(19) United States
(12) Patent Application Publication
(10) Pub. No.: US 2019/0289017 A1
(43) Pub. Date: Sep. 19, 2019

(54) TIME AND LOCATION BASED AUTHENTICATION CREDENTIALS

(71) Applicant: CA, Inc., Islandia, NY (US)

(72) Inventor: Gaurav Agarwal, Bangalore (IN)

(21) Appl. No.: 15/920,973

(22) Filed: Mar. 14, 2018

(51) Int. Cl. H04L 29/06; H04L 9/32; H04L 9/08; H04L 9/14

(52) U.S. Cl. CPC H04L 63/107; H04L 63/08; H04L 9/14; H04L 9/3242; H04L 9/088; H04L 63/108

(57) ABSTRACT

Provided is a process, including: receiving, a first request to generate a limited-use authentication credential; obtaining, a shared-secret value; determining, a measured geolocation of the credential-generating computing device; determining a coarser-geolocation-based value based on the measured geolocation; determining, a use-limiting value that constrains an amount of times generated credentials are valid or a duration of time over which generated credentials are valid; generating a limited-use authentication credential from one or more cryptographic hash values based on the shared-secret value, the coarser-geolocation-based value, and the use-limiting value; outputting the limited-use authentication credential for submission to the remote authentication application; generating an expected limited-use authentication credential based on a value indicative of a valid geolocation of a user associated with the shared-secret value; determining that the expected credential corresponds to a received limited-use authentication credential output by the credential-generating computing device, causing the user to be authenticated.

### CROSS-REFERENCE TO RELATED APPLICATIONS

No cross reference is presented at this time.

### BACKGROUND

### 1. Field

The present disclosure relates generally to information security and, more specifically to location verification using time and location based one-time passwords (TLOTP).

### 2. Description of the Related Art

One time password (OTP) is a multi-factor authentication technique used to authenticate a client device to access resources like a network, a server, an application, or other data repositories. Commonly-applied security measures for online access only require a username and user-supplied password, which has become increasingly vulnerable due to brute-force attacks and data breaches revealing passwords reused across sites. To mitigate this risk, industry has augmented (or replaced) these credentials with one-time passwords. OTPs are time-based credentials that periodically change, which renders a leaked OTP useless relatively quickly.

However, many traditional time-based one time passwords (TOTP) are relatively low-entropy, meaning that the TOTP is chosen from a relatively small space of candidate TOTPs, making this approach potentially vulnerable to low-latency brute-force attacks, where the space of candidate TOTP's is systematically tested. This risk is expected to become more acute as more powerful computing resources come online.

### SUMMARY

The following is a non-exhaustive listing of some aspects of the present techniques. These and other aspects are described in the following disclosure.

Some aspects include a process of determining a limited-use authentication credential based on geolocation, the process includes: receiving, with one or more processors of a credential-generating computing device, a first request to generate a limited-use authentication credential; obtaining, with one or more processors of the credential-generating computing device, a shared-secret value, wherein the shared-secret value is accessible to both of the credential-generating computing device and a remote authentication application; determining, with one or more processors of the credential-generating computing device, a measured geolocation of the credential-generating computing device; determining, with one or more processors of the credential-generating computing device, a coarser-geolocation-based value based on the measured geolocation of the credential-generating computing device, wherein the coarser-geolocation-based value is based on a coarser indication of geolocation than the measured geolocation, such that the coarser-geolocation-based value corresponds to a larger geographic area than the measured geolocation, the larger geographic area including the measured geolocation; determining, with one or more processors of the credential-generating computing device, a use-limiting value that constrains an amount of times generated credentials are valid or a duration of time over which generated credentials are valid; generating, with the credential-generating computing device, a limited-use authentication credential from one or more cryptographic hash values based on the shared-secret value, the coarser-geolocation-based value, and the use-limiting value; and outputting, with the credential-generating computing device, the limited-use authentication credential for submission to the remote authentication application, wherein the remote authentication application is configured to execute operations including: generating, either before or after generation of the limited-use authentication credential, an expected limited-use authentication credential based on a value indicative of a valid geolocation of a user associated with the shared secret, and determining that the expected credential corresponds to a received limited-use authentication credential output by the credential-generating computing device and, in response, causing the user to be authenticated.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a physical and logical architecture block diagram showing an example of a time-and-location one time password system in accordance with some embodiments of the present techniques;

FIG. 2 is a multi-entity flowchart showing messages that may be passed when authenticating a user with the system of FIG. 1 in accordance with some embodiments of the present techniques; and

FIG. 3 shows an example of a computer system by which the above techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of information security. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Organizations need stronger authentication options. Static password authentication is no longer considered secure for some use-cases due to user's tendency to favor weak passwords (which is not to suggest that this or any other sub-optimal technique discussed herein is disclaimed or may not be used on combination with other techniques described below). Many enterprise networks, online communities, and web sites only require a username and static (e.g., changed less often than once a week) password for logon and access to sensitive data. This authentication method is convenient for the users, which is a desirable attribute, however, it presents tradeoffs with respect to various attack vectors, such as keylogging, man-in-the middle attacks, phishing, and the like.

Other approaches to provide secure access have been proposed, including multi-factor authentication with one-time-passwords. Incorporating an additional security credential, for example, a one-time password (OTP), bolsters the protection afforded by static passwords by making it difficult to gain access after the OTP changes. OTP systems impede or prevent some forms of identity theft (or other malicious forms of network access) by decreasing the likelihood of a captured username-and-password pair being used a second time. Typically, the user's logon name and password stays the same across authenticated sessions, and the one-time password changes with each logon. As mentioned above, though, this technique is expected to provide less robust protection in the future as brute-force attacks become faster.

Many time-based OTP (TOTP) approaches use a static shared secret value and store it in plain-text form on the mobile device or other user-computing device. Then a time stamp is typically used as a seed to generate the TOTP. The result is a value that may become relatively computationally inexpensive to guess, particularly if the mobile application is not PIN protected. None of which is to suggest that these approaches or any other subject matter is disclaimed, as the present techniques may be used to augment various approaches like this.

The generation of OTPs can be accomplished in several ways, each having trade-offs in terms of security, convenience, accuracy, and cost. Examples include transaction numbers lists and grid cards that provide a set of one-time passwords. Another technique is the use of an OTP token, which is a hardware device capable of generating OTPs, e.g., with the output of a linear shift register. Some such devices are PIN-protected, offering an additional level of security. To us these systems, the user may submit the OTP with other identity credentials (username and password) to an authentication server that validates the logon request based on whether the supplied credentials are valid. Deployment costs can make this approach expensive for some applications. The OTP generation routine client-side often must be using the same routine as the server. Therefore, a separate token is often used for each system for which a user seeks access, often requiring users to need a separate token for each website or network they use.

As noted above, time based one-time password (TOTP) often provide secure access from a client device to a network, server, application, etc., by generating a OTP based on a time stamp of the current time and a shared secret value. TOTP is based on a HMAC (hash-based message authentication code) based one-time password HOTP. A cryptographic hash function may be implemented to generate the one-time password by generating a cryptographic hash of the current time and a shared secret value to which both the client and authentication system have access. This approach can lead to some user-experience issues in corner cases. Network latency and out-of-sync clocks can result in the user attempting multiple passwords to authenticate access. To mitigate this potential nuisance, the time stamp is often quantized into 30 second intervals, allowing for passwords generated in close time proximity with the same shared secret value to be equal. Thus, in this scenario, a given OTP may be the same over a 30-second window, and then the OTP may change when the quantized clock value increments to a subsequent 30-second window.

In an example implementation, the user enters their username and password into client-device application connected to a server via a network, and the application generates a one-time password for the server using an instance of a TOTP algorithm running locally on, e.g., a mobile device (which may be the same or different from the client device) and types the generated password into the application, which sends it to the server. The server then runs a TOTP algorithm to verify the entered one-time password. In order for access to be granted, the clocks of the user's device and the server may need to be roughly synchronized (e.g., the server may accept one-time passwords generated from timestamps that differ by ±1 time interval from the client's timestamp). A single shared secret value, to be used for all subsequent authentication sessions, may have been shared with the server and the user's device over a secure channel in advance of authentication, for instance at the time of creating the account, and the client and server may each calculate a hash value based on both the a locally created time stamp and the shared secret. To authenticate the user, the server may determine whether a received hash value matches a locally created hash value. Security of TOTP may be lacking, though, in some cases, because an adversary may steal the shared secret value and generate a new and valid TOTP codes, and some implementations may be vulnerable to session hijacking and lost and/or stolen phones (again, none of which is to suggest that these or any other features described herein are disclaimed).

Some embodiments mitigate some or all of the problems as discussed above, as well as other problems discussed below and those that will be self-evident to one of ordinary skill in the art with knowledge of open issues in the field. Some embodiments may incorporate a user's current location for verification along with possession of a token in a way that mitigates problems with doing so using more naive computational approaches, e.g., those that are not robust to noise in location measurements. Some embodiments may identify a geographical area (of appropriate granularity, such as less than 100 square km, 10 square km, 1 square km, 100 square m, 10 square m, or 1 square m) for a particular location of the user. In some instances, a data model is implemented in which Earth is divided into multiple geographical areas by grouping contiguous ranges of latitudes and longitudes, such that each location point belongs to a specific latitude and longitude group. In some embodiments, the determined latitude group (Glat) and longitude group (Glong) may represent a geographic area where a given latitude, longitude falls. In some cases, Glat may be calculated by adding a constant to a measured latitude to transform negative values into positive (and avoid having the same distances from the equator in the Northern and Southern hemispheres producing the same Glat values). In some cases, Glat and Glong may be measured latitude and longitude values with a threshold number of significant digits and less significant digits discarded (or produced by rounding to a multiple of 10 or some other quantization interval). Some embodiments may determine a location based or time and location based OTP (TLOTP) based on Glat and Glong (or other quantizations of geolocation, e.g., hexagonal tile in a hexagonal grid).

In some cases, the TLOTP may be the output of a cryptographic hash function (like SHA1, SHA-256 or MD5) taking as input a quantized measure of time determined by the user's mobile computing device, a quantized measure of geolocation determined by the user's mobile computing device, and a shared secret value possessed by the user's computing device and an authentication server. In some cases, the size of quantization intervals (e.g., the reduction in granularity of measured times and locations) may be selected to mitigate the effects of noise in measured values on authentication determinations, while keeping the values precise enough to make brute force attacks difficult. Such tradeoffs are expected to depend on the use case and balancing between risk and convenience. In some cases, a resulting TLOTP may be sent by the user's mobile device (or entered by the user into another device that sends the value) to an authentication management system.

The authentication management system may re-create the TLOTP. The authentication management system may apply the same cryptographic hash function and input to this function a time, either determined by applying the same quantization transformation (e.g., by interval and phase) to a time output of the authentication management system's clock or a quantized time associated with the sent credential (which may be rejected if that time is more than a threshold duration from a time determined by the authentication management system's clock). The authentication management system's cryptographic hash function may further take as inputs values retrieved from a profile of the user in a repository of the authentication management system and associated in the repository with a unique user identifier sent with the TLOTP. The retrieved values may include the shared secret of that user and a value based on the geolocation of that user. (Other users may have other profiles with other shared secret values and other geolocation-related values.) The retrieved geolocation-based value may be a quantized expression of geolocation previously supplied by the user and associated with the account, e.g., during account registration based on a geolocation sensed by the user's mobile computing device. The same quantization transformation of geolocation may be applied to the previously obtained geolocation in the user's profile. In some cases, to facilitate grater privacy, the TLOTP calculation on both the client and server side may be based on a cryptographic hash of the geolocation of the user, so that the server does not store the user's geolocation in unencrypted form. These retrieved values may also be input to authentication management system's cryptographic hash function to produce a re-created TLOTP. The server may then determine whether to authenticate the user based on whether the received TLOTP matches the TLOTP calculated by the authentication management system.

To increase further mitigate the effects of noise, in some cases, the authentication management system may calculate a two or three dimensional matrix of TLOTP for adjacent quantization intervals in time and space and, then, determine whether the user is authenticated based on whether the received TLOTP matches any calculated TLOTP values in the matrix. For instance, the authentication management system may calculate TLOTP values for plus or minus a threshold amount (e.g., less than 2, less than 4, or less than 8) adjacent intervals in Glat, in Glong, and in time, and every permutation thereof to form a three dimensional matrix of candidate TLOTP values to which the received TLOTP value is compared. In some cases, a match to one may cause the authentication management system to designate the user as being authenticated.

The increase in entropy of the OTP from including location may facilitate various relaxation of other design parameters (e.g., larger time intervals for time quantization) or those design parameters may be held constant while hardening the system to brute force attacks. Variations described below may introduce additional entropy with, for instance, reference to biometric measurements and location history in inputs to the TLOTP cryptographic hash function inputs. Example use cases include authentication for virtual private network logins, payment authentication, authentication to single-sign-on systems, and the like.

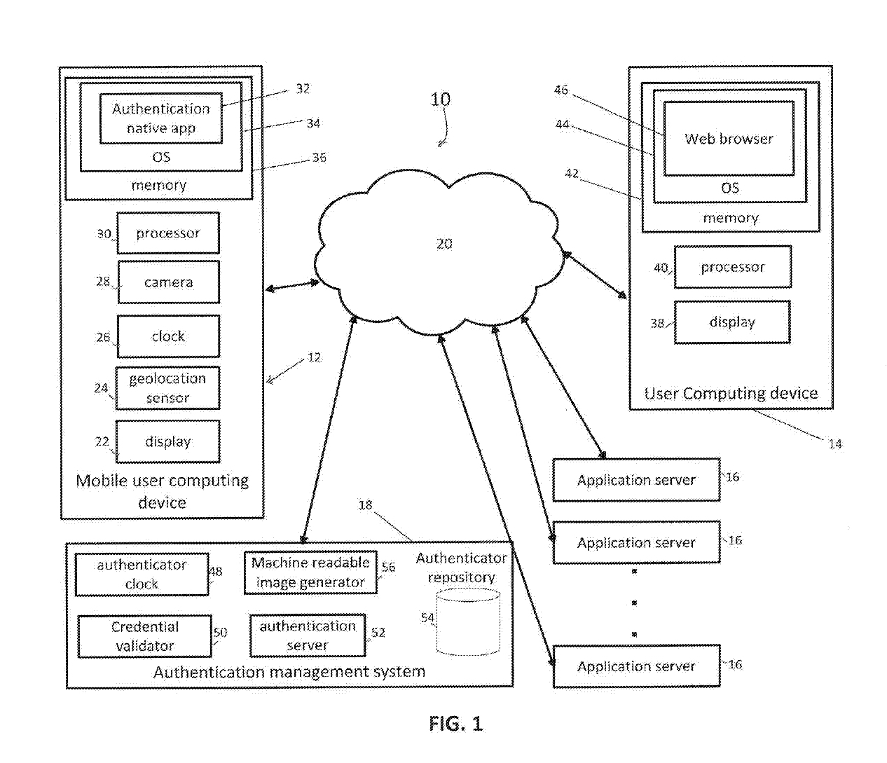

In some embodiments, the above described features may be implemented in a computing environment 10 shown in FIG. 1. It should be emphasized, though, that not all embodiments include all of the above-described features, afford all of the above-described benefits, or partially or fully mitigate all of the above-described problems, which is not to suggest that any other description herein is limiting. Rather, multiple, independently useful techniques are described, with various engineering and cost trade-offs, and some embodiments may implement some of those techniques while not implementing others.

As shown in FIG. 1, some embodiments may include a pair of computing devices of a user (e.g., physically co-located with the user such that the user can concurrently physically manipulate inputs thereto), in this case a mobile computing device 12 (e.g., tablet, smart phone, wearable, etc.) and a user computing device 14 (another mobile computing device, desktop, laptop set-top box, in-store kiosk, automated teller machine, etc.). The environment 10 may further include a plurality of application servers 16 that may host remote (relative to the user, e.g., more than 1 km away, or accessible via a public or private network) resources the user seeks to access with the user-computing device 14. Some embodiments may further include an authentication system 18 that determines whether to authenticate users seeking access on behalf of the application servers 16 by interfacing with the user computing devices 12 and 14, in accordance with the techniques described below, and causing signals to be sent (e.g., directly or via client devices) to the servers 16 indicate a result of an authentication determination.

A single pair of user computing devices 12 and 14 for an individual user are shown, but embodiments are consistent with substantially more pairs of computing devices, and may include in commercial implementations more than 100, more than 1,000, more than 10,000, or more than 1,000,000 pairs of computing devices seeking authentication (e.g., concurrently or over a one year period). Similarly, three application servers 16 are shown by way of example, but some embodiments may include a single application server 16, which may be integrated with the authentication system 18. Some embodiments may include substantially more application servers 16, for instance more than 10, or more than 50 different application servers for more than 10 or more than 50 different web applications or application program interfaces at distinct web domains or data centers. In some embodiments, the illustrated components may communicate with one another via one or more networks 20, such as the Internet, various local area networks, cellular networks, wireless area networks, and the like.

In some embodiments, the mobile user computing device 12 may be a smart phone, a wearable computing device, a tablet computer, a laptop computer, a smartwatch, a head mounted display, or the like. In some cases, a non-mobile computing device may serve the role of the mobile user computing device 12. In some embodiments, the mobile user computing device 12 may include an onboard power supply, such as a battery and one or more radios by which wireless network access is provided to the network 20.

In some embodiments, the mobile user computing device 12 includes a display 22, a geolocation sensor 24, a clock 26, a camera 28, a processor 30, and memory 32 (e.g., persistent or volatile data storage) storing program code of an operating system 34, and an authentication native application 36, in some cases among various other native applications. In some embodiments, the processor 30 may coordinate the operation of other components illustrated and execute program instructions stored in memory 32, including executing the operating system 34 and the native application 36, in some cases interfacing on behalf of the native application 36 with the various illustrated hardware through various program interfaces provided by the operating system 34.

In some embodiments, the processor 30 may execute program code of the native application 36 that causes the native application to provide the functionality described below, which is attributed to a mobile computing device, and some cases causing the camera to sense, for instance, capturing an image of or video feed of, a field view of the camera 28, which a user may position to include the display of the user computing device 14 described below. In some embodiments, the camera 28 is a rear facing camera or a front facing camera of the mobile user computing device. In some embodiments, the camera 28 includes both an optical camera and a depth sensing camera, such as a time-of-flight camera, or a camera configured with an accompanying projector that projects a pattern of infrared symbols onto a region within a field of view of the optical camera. In some embodiments, the camera 28 is operative to detect these projected patters or receive time-of-flight measurements and calculate a three-dimensional image including both pixel intensities and depth values indicative of distance between the camera and regions in a field of view corresponding to the pixels.

In some embodiments, the processor 30 may execute program code of the native application 36 that causes the native application to provide the functionality described below, which may be attributed to a mobile computing device, and in some cases causing the geolocation sensor 24 to sense the location of the mobile computing device. To this end or others, the geolocation sensor 24, such as a global positioning system sensor, a GLONASS sensor, Galileo sensor or the like, operative to sense a geolocation of the mobile computing device based on timing signals in beacons transmitted by arrays of satellites received by the sensor, in some cases, outputting a latitude and longitude.

In some cases, the native application 32 may call a location framework or library of the operating system. In some cases, the native mobile application on the mobile user devices queries the operating system of the device to obtain a geographic location of the device. For example, some examples of native applications executing the IOS™ operating system may instantiate a member of the CLLocationManager class provided within that operating system and use methods of the class to obtain the geolocation of the mobile user device. In another example, some examples of native applications executing on the Android™ operating system may instantiate a member of the LocationProvider class provided by the operating system and use methods of the class to obtain the geolocation of the mobile user device. Some embodiments may register to receive updates to location, query these interfaces for a current location, or query these interfaces for last known or previous location. Some embodiments may modulate a desiredAccuracy input to specify a granularity of location measurement, e.g., to tradeoff between battery consumption/speed penalties for more accurate measurements afforded by satellite navigation systems and relative battery consumption/speed advantages of more granular measurements from cell tower identifier, WiFi SSID, and cell-tower triangulation based techniques. Some embodiments may modulate this setting to avoid requiring satellite navigation based measurement to provide a more response interface to the user while affording sufficiently accurate location measurements. In some cases, the below-described location inputs may be a set of locations, such as a set of locations above a threshold (like the top two or three) in a location history of the mobile device (like those designated as “visited places” by the operating system). Using multiple locations may facilitate coarser-grained geographic areas in subsequent operations, which may further mitigate effects from noise in geolocation measurements causing false negative authentication results.

Location may be established by various techniques, i.e. global positioning system (GPS), Wi-Fi based position, and cellular network based positioning. GPS based positioning is the positioning techniques mostly used by mobile computing devices. GPS positioning is based on the reception of signals continuously transmitted from satellites. These received signals may contain the precise time the message was sent, as well as the location in orbit of the satellite. The GPS receiver uses the received signals of four or more satellites to calculate the current position based on trilateration. When outdoors, GPS receivers within mobile computing devices may be able to reduce the positional error to a few meters. Some satellite systems, such as GLONASS and Galileo may provide better even localization accuracy than GPS, e.g., where line of sight is not available. In some cases, the quantized location may be expressed with an identifier that serves as a proxy for location over some area, like a ZIP code, a city name, a WiFi SSID, a cell-tower identifier, a public Internet Protocol address, or the like.

WiFi™ based positioning may sense beacons from WiFi™ access points to determine the position of the mobile computing device. WiFi™ access points periodically transmit beacons, e.g., every 100 milliseconds, including an access point identifier (e.g., a SSID), to their surrounding area to inform potential WiFi™ clients, such as a mobile computing device, about their existence. The mobile computing device may receive the access points identifier encoded in the beacons and query databases that associate SSID's with geolocations, via the Internet, to determine the locations of the surrounding access points, by searching the identifier in the database. Depending on the number of access points in range, the achieved location accuracy of WiFi™ based positioning may vary between a few meters to 100 meters. WiFi™ based positioning may be used indoors as well as outdoors. However, the number of available access points differ greatly between urban and rural areas, making WiFi™ based positioning a technique to more suitable for used in cities with many existing and known access points. Access points may also be used to transport needed information to the GPS sensor onboard the mobile computing device, aiding the GPS receiver to fix quickly. In some cases, WiFi beacons may include a relatively fine-grained transmission timestamp, and some embodiments may determine a difference between a current time and the transmission time to infer a time-of-flight and distance.

Cellular network based positioning may use cell-tower identifiers or tower identifier and triangulation techniques to calculate the current mobile computing device's location. The cellular network may be divided into cells, in which each cell has a unique identifier, cell-ID. Depending on the triangulation technique used to determine the current mobile computing device's location and the cell size, cellular network based positioning accuracy may range between 50 meters to a few kilometers. Referencing a single tower identifier in range may be sufficient to determine location to within a less than five kilometers of the actual geolocation.

In some instances, authorized access may be determined based the latitude and longitude of the mobile computing device being within a boundary, i.e. a circle or polygon (like a grid square or hexagon in a hexagonal grid), defining a geographic area. The area definition may be extant regardless of the mobile device's location, and some embodiments may determine whether the mobile device is in the area. In some instances, the area may include a point and radius, e.g., the point may be defined a longitude and latitude and the radius may be the distance from the circle's center to the circle's perimeter. Or in some cases, a polygon may be referenced. The resulted polygon may include a geometry type (e.g., square, convex, concave, hexagon, octagon, etc.) and latitude and longitudes of vertices. In some embodiments, the measured location may quantized to a coarser geographic area by identifying a geographic area in which the measured location falls, e.g., a grid square including the geographic area, a hexagon in a hexagonal tiling, or some other coarser indication of location, such that measurement error around the user's actual geolocation within some threshold (e.g., less than 1 meter, less than 10 meters, less than 100 meters, less than 1 km, or less than 10 km) produces the same lower-resolution, lower-granularity output. Grid squares may serve this purpose with relatively low computational overhead, as latitude and longitude measurements may be expressed with fewer significant digits to convert a measured location into an identifier of a grid square including that location. In some cases, the lower-resolution area is identified with a unique identifier specified, e.g., with a space filing curve, like a Hilbert curve, Z-curve, Lebesgue curve, or Morton curve, that affords relatively fast selection of geographically adjacent areas, as such areas may be positioned in adjacent data entries indexed by such identifiers.

In some embodiments, an initial registration may be created where a shared secret value (e.g., a randomly generated string with greater than 2,000, greater than 4,000, or greater than 8,000 bits of entropy) is generated by the server and delivered to the client (e.g., with Diffie-Hellman public key encryption being used to establish an encrypted channel through which a symmetric key that serves as the shared secret is exchanged), without sharing the shared secret value explicitly on the display 42 of the user computing device 14.

In some instances, a user supplies an identifier, e.g., a username or biometric measurement, and a credential, e.g., a password or biometric measurement, or in some cases simply upon applying a user identifier, to an application on the user computing device 14 (like web browser 46). The web browser 46 may receive instructions to display a machine readable code configured to facilitate the initial registration session (e.g., a QR code registered to an intent on the mobile device that launches the native application 32 in a particular state) and in some cases convey information to the authentication native application 32. In some embodiments, the initial registration session may be enhanced by providing, in the machine-readable image, a set of features designed to be detected by the camera of the mobile user device. For instance, the display screen 42 may display white fields with various arrangements of black rectangles arranged over the display screen with dimensions that encode information. In some embodiments, the machine readable image may further include visual elements that encode machine readable data conveyed to the authentication native application 32. Examples of visual element that encode machine readable data are a barcode, a QR code, a pattern that is displayed on successive frames, for instance by flashing a pattern through successive frames, or other visual encoding. In some embodiments, the encode information may include a cryptographically signed value (like one that is later combined with the shared secret as a hash function input to form a TLOTP) from the authentication system 18, such as a value signed. The cryptographically signed value may be with a private cryptographic value associated with the public and cryptographic value stored in memory or otherwise accessible to the mobile user computing device 12, for instance receivable from the authentication system 18, via a side channel communication between the mobile user computing device 12 and the authentication system 18 upon scanning of the signature. In some embodiments, the encoded value may further include data that specifies a configuration of the initial registration session, and the authentication native application 32 may parse these encoded configuration values and configure the authentication user interface. In some embodiments, the encoded data may indicate an identifier of a user seeking authentication, and the authentication native application 32 may extract that identifier and send the identifier, or a value indicative of the identifier, to the authentication system 18 along with a user entered credential.

In some embodiments, the application servers 16 may entry points to various types of distributed applications, as discussed above, for instance, provided by a microservices architecture with a plurality of servers behind load balancers, at one or more web domains at which various web applications or application program interfaces of native applications are accessible. In some embodiments, the application servers 16 may be configured to send an initial user interface to a user computing device 14 after receiving a request to access resources, such as a web application or other application program interface. In some embodiments, the sent user interface may include web browser instructions, resources, scripting language commands, and the like that are executed by a web browser 46 to form the user interface on the user computing device 14 and cause the user interface to be displayed on display 38. In some embodiments, the user interface may include inputs, such as text box inputs, by which a user supplies a user identifier and a knowledge factor credential, e.g., a password, and in some cases, another input to supply a TLOTP read from the display screen of the mobile device 12 (or in some cases, the TLOTP may be sent by the mobile device 12 to the authentication management system 18 along with an identifier captured (e.g., upon scanning a QR code with camera 28) from display screen 38. In some cases, one or both of passwords or user identifiers may be retrieved from a persistent client-side data repository, like a cookie, local storage object, SQL light database, or the like, and providing these values may be achieved by providing a value demonstrating possession of these credentials, e.g., a cryptographic hash of a password. For instance, the retrieval may be implemented by executing a corresponding portion of sent scripting language commands that retrieve these values and send them back to the application server 16.

In some cases, upon a user computing device 14 requesting to access resources at a server 16, the application server 16 may redirect the web browser 46 to the authentication system 18, or embed content from the authentication system 18, that includes a user interface. In some embodiments, the redirect command may include a uniform resource identifier of the application server 16, among each of the application servers 16 serviced by the authentication server 18, along with a unique identifier. The unique identifier may track an authentication session such that subsequent interactions may be tied back to the application server 16 by the authentication system 18. The user's computing device may be redirected back to the appropriate application server 16 upon authentication by the authentication system 18, for instance by retrieving a uniform resource identifier of the appropriate application server 16 based upon the identifier in the redirect command sent to the web browser 40. This redirect command may cause the web browser 46 to execute a get request to the application server 16 that conveys that identifier in the URL. In some cases, upon authenticating the user, the web browser 46 may then be redirected again, for instance, sent another URL selected based upon the identifier of the application server 16. In some cases, that redirect command may include an authentication token as a query parameter in a URL sent to the web browser 46, which causes a web browser 46 then send a request to the application server 16 including an authentication token.

The authentication token may be a value cryptographically signed with a private key of the authentication system 18 and validated by the application server 16 based upon a public key of system 18 and a cryptographic key corresponding to that private key. Thus, in some embodiments, a user may be authenticated by the authentication system 18 on behalf of a given application server 16 without direct communication between the application server 16 and the authentication system 18, by communication via query parameters in URIs in redirect instructions into the web browser 46. Or in some embodiments, the application server 16 may communicate directly with the authentication system 18, for instance via a back channel communication via the network 20 that does not pass through the web browser 46. Thus, in some cases, the application server 16 may embed content sent to the web browser 46 or pass through content retrieved from the web browser 46, such as user credentials and identifiers sent to the authentication system 18. In some embodiments, the authentication system 18 may send a result of authentication to the application server 16 via this back channel communication.

Upon a user not being authenticated, in some embodiments, the application server 16 may decline to provide access to the requested resources by the user computing device 14, in some cases providing an indication of why access was not granted may be provided, for example, indicating that a user credential was incorrect. Alternatively, upon a user being granted access, for instance upon the user supplying the appropriate user identifier, knowledge factor credential, and demonstrating possession of the mobile user computing device 12, the application server 16 may then provide access to the requested resources, for instance by sending subsequent user interfaces containing information that would not otherwise be available and responding to subsequent commands, like various queries from the user computing device 14. In some embodiments, the user computing device 14 may be sent an authentication token that may be included in subsequent exchanges in a given authenticated session to indicate to the application server 16 that the subsequent request is part of an authentication's authenticated session. In some embodiments, when responding to subsequent requests, the application server 16 may validate that the subsequent request is associated with a valid authentication token. In some embodiments, these authentication tokens, i.e. one-time passwords, may be expired by the application servers 16 and cease to be honored, for instance after a given session ends or after a threshold amount of time has elapsed, in which case, the user may be forced to seek re-authentication with the techniques described above.

In some embodiments, the authentication system 18 may be configured to determine whether to authenticate a user on behalf of the application servers 16, for instance, with the exchanges described above via the web browser 46 or via direct exchanges with the application servers 16. In some embodiments, upon a user supplying an identifier, and in some cases upon a user supplying a knowledge factor credential, like a password, the authentication system may cause the native application 32 to present a limited-use authentication credential user interface in which an additional input is supplied by the user. In some embodiments, upon a user supplying their user identifier, the authentication system 18 may access the user profile and identify an address of the mobile user device 12 or of the authentication native application 32. The identified address, in some cases, may be a port and Internet Protocol address. In some cases, the identified address may be a device identifier and application identifier registered through a notification serve provided by a provider of the operating system 34 and which the native application 32 has registered with the operating system 34. In some embodiments, messages from the authentication system 18 that cause the native application 32 to present an authentication user interface may be pushed or pulled.

In some embodiments, the authentication system 18 may include an authenticator clock 48, a credential validator 50, an authentication server 52 a machine readable image generator 56, and an authenticator repository 54. In some embodiments, these components may execute operations coordinated by the authentication server 52, for example, responsive to communication from the application servers 16, the user computing device 14, or the mobile user computing device 12. In some embodiments, the authentication server 52 may receive a message from the application server 16 or the user computing device 14 indicating a user identifier and user credential. In response, the authentication server 52 may access the authenticator repository 54 to identify a user profile corresponding to the user identifier and, in some cases, validate that a user supplied password is correct. In some embodiments, passwords or other credentials may not be sent by the user computing devices 12 or 14, but rather a value demonstrating possession of such a credential may be sent. For example, a cryptographic hash of a user credential may be sent instead of the user credential itself in plain text form, and some embodiments may determine whether a cryptographic hash value stored in memory of the authentication system 18 and a user profile matches the received cryptographic hash value. In another example, a value may be cryptographically signed based upon the user credential, and some embodiments may determine whether a public key corresponding to the user credential corresponds to the received value.

In some embodiments, the authentication server 52 may cause the authentication native application 32 to present the above-described authentication user interface on the display 22. The authentication server 52 may then receive from the authentication native application 32 a subsequent value entered by the user, such as another credential or value demonstrating possession of the user entered credential. In some embodiments, the authentication server 52 may then engage with the credential validator 50 to determine whether the received second credential matches a value stored in the authenticator repository 54.

In some embodiments, the machine-readable image generator 56 may generate the above-described machine readable images. These images may include features that encode data conveyed to the authentication native application 32 via the display screen 38 to the camera 28, like cryptographic signatures and configuration key value pairs encoded in QR codes or barcodes. In some cases, generating the machine-readable images may include forming a bitmap, such as a compressed bitmap, like a JPEG or PNG file, that is sent to the web browser 46. In some embodiments, generating the machine-readable image may include constructing a command with parameters that causes client-side executed code to generate the machine readable image, for instance forming shapes with cascading sheets commands or JavaScript or web assembly commands parametrically, or forming a barcode or QR code client-side. Or some embodiments may operate without visual transmission of information between devices 12 and 14 or with a single one of these devices client-side, which is not to suggest that any other feature is limiting.

In some embodiments, the authentication server 52 may request a machine readable image from the machine readable image generator 56 and send a responsive image to the web browser 46 for presentation on the display 38. In some embodiments, the authentication server 52 may include a request to the machine readable image generator 56 parameters to be conveyed to the authentication native application 32, like those described below by which limited-use authentication credential user interfaces are configured or the image on the display 38 is authenticated, having been sent from the authentication system 18.

In some embodiments, the credentials validator 50 may be responsive to received credentials passed to the authentication server 52, such as user credentials entered via the web browser 46 or the authentication native application 32. In some embodiments, the credential validator 50 may compare a received credential to a credential stored in a user profile in the authenticator repository 54 corresponding to a user identifier associated with the request for authentication. In some embodiments, as noted, values indicative of possession of a user credential may be received, and in some embodiments the credential validator 50 may validate that the user has demonstrated possession of the user credential without actually obtaining the user credential itself in plain text form.

In some embodiments, the authenticator repository 54 may store a plurality of user profiles, for example in relational or nonrelational database. In some embodiments, each user profile may include a user identifier for a given user on a given application server 16, or in some cases, the same user identifier may be shared across multiple application servers 16 posting multiple web applications or other application program interfaces. Each profile may include the shared secret value specific to a user. Each profile may also include a value indicative of a geographic area, like a quantized geographic measurement. Examples include a grid square identifier, a hexagonal grid identifier, a ZIP code, a city name, a wireless radio identifier (like a WiFi™ SSID or cell tower identifier) or the like. In some cases, the value indicative of a geographic area may be obfuscated, e.g., stored in an encrypted form that is used both client and server-side to calculate TLOTPs. In some cases, each profile may store a plurality of geographic areas in association with a user profile, like a home and work geographic area, and users may be authenticated based on whether a supplied TLOTP matches a TLOTP calculated by the system 18 for any one of these different geographic areas (or adjacent areas). The geographic areas in the profile may be chosen according to a variety of criteria. In some cases, the geographic area may be bounding polygon, tile, or other geofence associated with a user's home geolocation registered for VPN access. In some cases, different geographic areas may serve to authenticate a given users for different services or different levels of access, and different geographic areas may be selected for calculating the server-side TLOTP based on the services or levels of access for which authentication is requested. In some cases, the geographic areas may be determined by clustering a location history of the user, e.g., with a DB-SCAN clustering algorithm in geolocation and time and defining the geographic areas with a convex hull of a threshold number of clusters in a ranking of clusters by dwell time. In some cases, different geographic areas may be associated with different windows of time in which the geographic area is qualified for use in a TLOTP, e.g., excluding a work geographic area during nighttime hours, and geographic areas may be selected for server-side TLOTP based on a time of day at which authentication is requested. In some cases, the geolocation may be received from other channels during an online transaction. For example, a merchant server may receive and then send a user's geolocation to authenticate a transaction with a bank on behalf of the user. In this example, TLOTP map be used to verify a geolocation received from an untrusted channel and then used for further risk assessment, e.g., calculating a risk score that is compared against a threshold to determine whether to permit the transaction, where the risk score is based on the geolocation and a probability of the user being in that geolocation given a geolocation history of the user.

In some embodiments, each of these user identifiers may be associated with a corresponding knowledge factor credential, like a password or other value by which a user demonstrates possession of the knowledge factor credential. Examples include a salted cryptographic hash calculated based upon a user password, such that the user password is not shared in the user profile, but a corresponding cryptographic has value sent by the web browser 46 may be compared against the cryptographic hash value in the user profile to determine whether the user is in possession of the knowledge factor credential, for instance upon the web browser 46 calculating the cryptographic hash value from a user supplied password or from a password stored in client-side memory. In some cases, a user may need to supply both a valid TLOTP and demonstrate possession of a password (or some measurable biometric attribute) to be authenticated.

In some embodiments, the user profiles include computing device profiles, for example for a given user, corresponding to the user computing device 14 and the mobile user computing device 12. In some embodiments, each user profile may include one or more, for example two, three, five or more computing device profiles. In some cases, each computing device profile may include the information described above by which a configuration of hardware and software on a computing device may be fingerprinted, and in some cases, descriptors of collections of features detected in images of one of the computing devices by another computing device. The features may include an image captured by the mobile user computing device 12 that may be classified as including the user computing device 14 or another user computing device associated with the user in the user profile, or not including one of these previously associated computing devices. In some embodiments, the above-described geolocation information associated with an individual user may be included in the user profile.

In some embodiments, the authentication server 52 may cause the authentication native application 32 to present the above-described authentication user interface on the display 22. The authentication server 52 may then receive from the authentication native application 32 or web browser 46 a subsequent value entered by the user, such as another credential or value demonstrating possession of the user entered credential along with a session identifier. In some embodiments, the authentication server 52 may then engage the credential validator 50 to determine whether the received second credential matches a value stored in the authenticator repository 54. The value received from devices 12 or 14 at server 52 may include a user identifier, a user password (or other credential), a TLOTP, and a session identifier by exchanges the server 52 matches networked exchanges with the device 12 to networked exchanges with the device 14. In some cases, each of these values may be received from one device 12 or 14, or a first subset may be received from one and a different (e.g., overlapping) subset may be received at server 52 from the other. In some cases, the credential validator 50 may apply a plurality of criteria, e.g., a password must match that associated with a user's profile and a TLOTP that is received must match that calculated by the credential validator based on information in a user's profile.

In some embodiments, the authenticator clock may generate a quantized timestamp of the authentication server 52 in interval of a few seconds, for instance an interval of less than or larger than 15 seconds, 30 seconds, 60 seconds, 120 seconds, or 240 seconds. In some cases, the quantization interval and phase may match that generated by native application 32, so that calculation of timestamps with clocks or network latency adding, for instance, two seconds of difference or less may result in the same quantized timestamp in both systems more than 80% of the time

In some embodiments, the user computing device 14 may include a processor 40 and system memory 42, storing operating system 44 and a web browser 46, or another native application configured to access a remote API for which authentication is sought. In some embodiments, the operating system 44 may be a desktop or a mobile operating system, which in some cases may be a different operating system from the operating system 34 of the mobile user computing device 12. In some embodiments, the memory 42 may include dynamic random-access memory that holds program state of executing applications and instructions, such as program code, by which those applications are implemented, along with instructions by which an operating system and agent describe below are implemented. In some embodiments, the system memory 42 includes random-access memory on a memory bus on a motherboard of the user computing device 14 and coupled to a memory controller of a central processing unit, not shown, via one or more channels. In some embodiments, the system memory 42 includes an operating system 44, such as the Windows™ operating system, a UNIX™ operating system, a version of the Linux operating system or a version of the z/OS™ operating system.

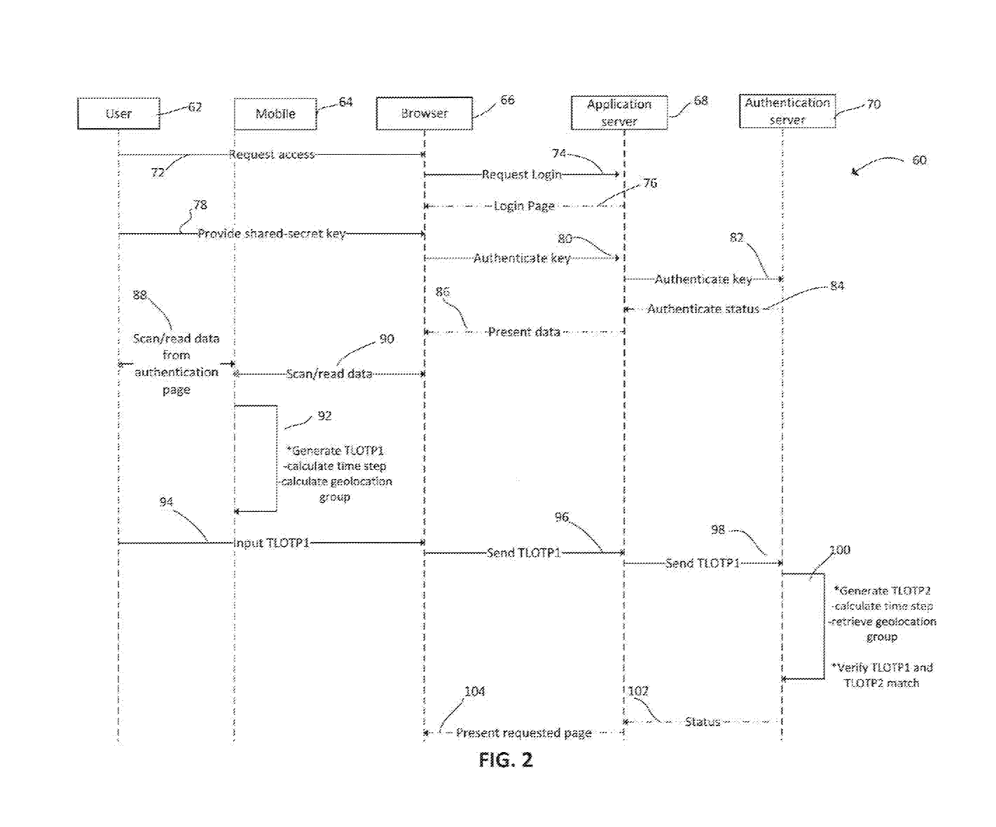

In some embodiments, a user may have navigated the web browser 46, or a native application, and supply user identifiers and credentials according with the process, described below with reference to FIG. 2, before engaging the mobile user computing device 12 to supply a second factor of authentication. In some cases, session identifiers may be communicated between the devices 12 and 14 via direct wireless transmission (e.g., scanning a QR code on one display with a camera of the other device, or near-field communication), or a session identifier may be pushed to (or otherwise associated with) the mobile device upon a user identifier being supplied via an input to the device 14 and an identifier of the mobile device being accessed in repository 54 in virtue of the mobile device being associated with the user identifier in one of the above-described profiles.

FIG. 2 shows an example of a process 60 that may be implemented in the computing environment of FIG. 1, but which is not limited to that implementation, which is not to suggest that any other description herein is limiting. In some embodiments, the functionality of the process of FIG. 2, and the other functionality described herein may be implemented with program code stored on a tangible, non-transitory, machine-readable medium, such that when the instructions in the program code are executed by one or more processors, the described functionality is effectuated. In some cases, different subsets of the program code may be stored on difference instances of media, for instance, on different computing devices that execute different subsets of the instructions, an arrangement that is consistent with the use of the singular term “medium” as used herein. In some embodiments, the described operations may be executed in a different order, may be replicated, may be executed sequentially, may be executed concurrently, may be omitted, may be replicated, or may be otherwise differently arranged from that shown in FIG. 2, which is not to suggest that any other description is limiting.

In this example, one human entity, user 62, is shown as participating in the process along with four different computing device entities, a mobile computing device 64, a web browser 64 (e.g., on another computing device different from the mobile computing device 64), an application server 68, and an authorization server 70. The first three of these may be co-located, while the others may be geographically remote from one another. In some embodiments, the user 62 may be a user of the computing devices 12 and 14 described above with reference to FIG. 1. In some embodiments, the mobile computing device 64 may be the mobile user computing device 12 described above, and the browser 66 may be the web browser 46 described above. In some cases, the application server 68 corresponds to the application servers 16 of FIG. 1, and the authorization server 70 is part of or implements the authentication system 18.

In some embodiments, the process 60 begins with a user interacting with the browser 66 to request access to resources available remotely over a network, as indicated by communication 72, which in some cases may include a user selecting a link or navigating the web browser in some other fashion. In some cases, the role of the browser 66 may be filled by a native application that accesses a remote application program interface.

Next, in response to the user's request, the browser may request access to the resources from the application server 68, as indicated by communication 74, for instance, by sending a GET request to an Internet Protocol address of the application server 68 indicated by a domain name service as corresponding to a uniform resource locator specified in the communication 72.

In some cases, upon receiving the request for access, the application server 68 may determine whether the request is associated with a currently authenticated session with the browser 66. In some cases, this may include determining whether an authenticated token is appended to the request 74, for instance as a query parameter, and determining that such an appended authentication token corresponds to a valid authenticated session, such as one that is not be expired, and corresponds to a list of authentication tokens that are validly stored in memory of the application server 68. Or in some cases, techniques like those described above by which a value demonstrate in possession of a password may be in place of sending the actual authentication token, for instance the application server 68 may receive a cryptographic hash value calculated based on an authentication token, or the requested access may be signed by a private key corresponding to the session held by the browser 66, and the application server 68 may verify the signature with the public key corresponding to the session provided by the application server 68 by the authorization server 70 in an earlier authorization.

Upon determining that the request for access 74 is associated with an already authenticated session, in some cases, the application server 68 may send the requested resources, such as a webpage content, files, application program interface request responses, or the like, back to the application executing client-side, such as the browser 66.

In the illustrated example, the application server 68 determines that the request for access 74 is not part of a currently authenticated session. In response, the application server 68 may respond by sending instructions to the browser 66 to display a user interface by which the user 62 may enter various user credentials, such as hypertext markup language instructions, scripting language instructions (e.g. JavaScript™ or WebAssembly), and various other resources, like images and styling instructions, back to the browser 66. In some embodiments, those instructions may include user interface inputs having corresponding event handlers configured to send data entered into the user interface inputs by the user 62 back to the application server 68 upon a corresponding event being sent to the even handler by the browser 66. Events may include an on click event, a key entry event, and on touch event, a touch release event, or other input gestures. In some cases, the instruction may include instruction that obtain other types of user credentials, such as a value indicative of a biometric measurement, e.g., one or more features in a facial scan or a fingerprint scan, or a cryptographic hash value or cryptographic signature sent by the client device responsive to the request or by some other third party biometric authentication service response to the request, back to the application server 68.

In the illustrated example, the user may enter their credentials, as indicated by communication 78, into the initial interface sent by the application server 68. For instance, the user may enter a username and password, as described above, or allow various biometric attributes of the user 62 to be scanned or otherwise submitted. In some embodiments, values indicative of the communication 78 may be sent by the browser 66 and back to the application server 68, as indicated by communication 80. In some cases, this may be the values themselves or various cryptographic hash values or encrypted encodings of these values.

In some embodiments, the application server 68 may then establish a back channel of communication with the authorization server 70 and request authentication of the user based on the supplied values and communication 80. In some cases, the application server 68 may be configured to hand off some or all of the authentication process to the authorization server 70 without establishing a back channel of communication. An example of such is by implementing an OAuth protocol, such as in the OAuth 2.0 specification. In some embodiments, the application server 68 may request authentication in communication 82 with a message or sequence of messages that include the user supplied credentials, user supplied values demonstrating possession of the credentials, or a value demonstrating possession of the credential by the application server 68, without revealing the actual credential itself In some embodiments, the request to authenticate the user 62 may include one or more of the attributes described above by which a computing device executing browser 66 may be profiled. Examples of such may include parameters in a user agent string in a hypertext transport protocol request from the browser 66 to the application server 68, or various other parameters gathered by a native application by querying an application on an operating system interface executing on the client device running the browser 66.

In some embodiments, in response, the authorization server 70 may identify a user profile corresponding to a user identifier supplied by the user via the browser 66 (or a native application on a client device). In some embodiments, the process 60 may then include the authorization server 70 determining whether supplied knowledge factor user credentials, or values demonstrating possession thereof, correspond to values in the user profile, for instance, determining whether the user has demonstrated that they are in possession of a password associated with the user identifier in the user profile. Some embodiments may further determine whether a computing device profile of the computing device executing the browser 66 matches a profile of a computing device stored in the user profile matching the user identifier.

In some embodiments, the above-described determination of whether the request for access 74 may be part of a currently authenticated session made by the authorization server 70. In some cases, that task may be offloaded to the application server 68. In some embodiments, the authorization server 70 may send a communication 84 back to the application server 68 indicating that the user is not currently authenticated and instructing application server 68 to instruct the browser 66, or native application, to present a user interface instructing the user to supply an addition authentication factor via the mobile device 64, e.g., along with the above-described machine readable image sensed by a camera of the mobile computing device 64 to configure the mobile device or along with pushing a message to the mobile device to launch the native application described above.

In some cases, the application server 68 may then cause the browser 66 to present this data, for instance with communication 86, which in some cases may include a communication responsive to communication 80 that encodes a new webpage that displays the instructions and, in some cases, the machine-readable image. In some cases, these instructions may include instructions that tell the user to supply a supplemental authentication factor with their mobile computing device. Or in some cases, a communication may be sent to the mobile computing device 64, such as a notification via a notification application program interface provided by a provider of an operating system of the mobile computing device, for instance to which a background process of the above-described native application has subscribed. In some cases, this notification may cause a notification to be presented on the mobile computing device by which a user may laugh an authentication native application like that described above. Or in some cases, the functionality of the authentication native application may be implemented in a web browser executing on a mobile computing device 64.

In some embodiments, the user may launch the authentication native application, as indicated by communication 88, and physically position a camera of the mobile computing device 64 such that the display screen of the computing device executing the browser 66 is within a field of view of the camera, as indicated by communication 90, which may include capturing video or one or more still images of the display screen of the browser, which may depict the machine readable image described above. Or some embodiments may engage the mobile device through pushed notifications or NFC exchanges.

In some cases, through these channels or others, the mobile device may receive an identifier of the authorization server and a value demonstrating possession by the authorization server 70 of an authorization server credential. Examples of these values are a value that is cryptographically signed with a private encryption key of the authorization server and corresponding to a public encryption key stored in memory of the native application, or a value that is otherwise secret. In some embodiments, the value encoded may be a value selected based on a mobile computing device associated with the user requesting authentication in the user profile. For example, the authorization server 70 may encode a different value that uniquely identifies different mobile computing devices associated with different users in the machine-readable image, such that the encoded value serves as a global unique identifier of the mobile computing device 64 and a namespace of the authorization server 70. The unique value, which in some cases may be a relatively high entropy value that is relatively difficult to guess, such as a random string greater than 256 bytes, may be stored in memory allocated to the native application executing on the mobile computing device 64. In some embodiments, the mobile computing device may determine, with a native application, whether the encoded value matches before proceeding, thereby making it difficult for third-party attackers to scan the image with a different mobile computing device, such as one in which a user's phone number has been maliciously remapped to an attacker's mobile computing device.

In some embodiments, the conveyed data may further encode a value demonstrating possession of a credential of the authorization server 70, as noted above. Some embodiments may further validate, with the native application executing on the mobile computing device 64, that the machine-readable image is authentic and from the authorization server 70 and not from an attacker's computing system, such as one implementing a man-in-the-middle attack and supplying a substitute machine-readable image.

In some embodiments, upon determining that the machine-readable image is not authentic, for instance doesn't correspond to the mobile computing device 64 or does not correspond to the authorization server 70, based on values encoded in the machine-readable image, the mobile computing device may terminate the process 60 and emit an alarm, for instance, sending an alarm to the authorization server 70, displaying a warning message to the user, and otherwise preventing the authorization server 70 from authenticating the user.

Alternatively, upon determining that the data encoded in the machine-readable image is authentic and otherwise valid, the native application on the mobile computing device 64 may present a user interface to the user 62 by which the user may supply additional credentials. In some cases, this may include the mobile user computing device 64 connecting to the authorization server 70 and indicating that the mobile computing devices engaged in an attempt to authenticate a user. In some cases, authentication may be with a value that uniquely identifies the mobile computing device 64, like the value described above that serves as a global unique identifier, or a value demonstrating possession of that value. In some embodiments, the authorization server 70 may determine whether the request matches a previously sent machine-readable image and upon determining the absence of a match, the authorization server 70 may terminate an ongoing session by which a user is attempting to become authenticated. Alternatively, in some cases, the server 70 may return parameters by which the mobile computing device 64 may supply additional credentials. The additional credentials may be an encryption key with which the mobile computing device 64 is to encrypt or cryptographically hash a user supplied credential, or parameters by which a one-time password is generated, or a public or private encryption key. Or in some cases, some or all of these parameters may be encoded in messages to the mobile device, for example in an encoded encrypted ciphertext, and the mobile computing device 64 may decrypt these values with a previously exchanged encryption key from the authorization server 70.

In some embodiments, these communications with the authorization server 70 may also specify a configuration of a user interface to be displayed by the mobile computing device 64 and receive additional credentials from the user 62. In some embodiments, these parameters may include a type of user interface, such as a keyboard, a swipe pattern (like a matrix, such as a two or three-dimensional matrix of icons between which the user sequentially swipes to enter a pattern), or other inputs by which a user may enter a relatively high entropy credential.

In some embodiments, upon determining the authentication request is valid, the mobile computing device 64 may receive a first request to generate a limited-use authentication credential (e.g., a TLOTP) with a client multi-factor authentication application installed as a native application, as indicated by communication 92. In some instances, the mobile computing device 64 may access the shared secret value. In some instances, the mobile computing device 64 may determine a use-limiting value that constrains the amount of times the shared secret value is valid, for example 1, 2, or 3 times, in some cases a duration of time may constrain the amount of times, for example, increments of a duration of time larger than 10-seconds that have elapsed since a predetermined time. In some instances, the mobile computing device 64 may determine a quantized-geolocation value based on a measured geolocation, as described above. In some embodiments, the mobile computing device 64 may generate a limited-use authentication credential from one or more cryptographic hash values based on the shared secret value, the coarser-geolocation value, a quantization of time, and the use-limiting value.

In some embodiments, the mobile computing device 64 may receive a second request to generate a limited-use authentication credential based on another measured geolocation of the mobile computing device 64 at a different time. In some cases, the server 70 may access a set of plurality of permitted geographic areas in which the user is permitted to authenticated stored by the repository 54. In some instances, the server 70 may determine that the other measured geolocation is not in any of the permitted geographic areas, and in response, an indication of the determination may be presented to the user, in some cases, the user may be blocked from accessing the application server 16.

In some embodiments, the coarser (relative to that which is measured) geolocation-based value may be based on a measured geolocation of the mobile computing device. In some cases, the coarser-geolocation-based valued may be based on a coarser indication of geolocation than a measured geolocation, for instance the coarser-geolocation-based value may correspond to a larger geographic area than a measured geolocation, the larger geographic area including the measured geolocation. In some embodiments, the coarser-geolocation-based value may be based on an identifier of a larger-geographic area, in some cases, based on a cryptographic-hash value based on the identifier of the larger geographic area.

In some embodiments, the coarser-geolocation-based value may be accessible to the authorization server 70, in some instances, value does not reveal the larger geographic area, in some instances, the value does not reveal the user's 62 measured geolocation. In some embodiments, the authorization server 70 may store a plurality of coarser-geolocation-based values associated with the shared-secret value, in some instances, the plurality of coarser-geolocation-based values may correspond to a plurality of different geolocations in which the user 62 may be permitted to be authenticated.

In some embodiments, the coarser-geolocation-based value may be based on a latitude or longitude of the mobile computing device 64. In some instances, the coarser-geolocation-based value may be based on a first subset of digits of the latitude or longitude, in some cases, the coarser-geolocation-based value is not based on a second subset of digits of the latitude or longitude, in some cases, the second subset may be less significant digits than the first subset.

In some embodiments, the coarser-geolocation-based value may correspond to a unit cell of a grid in response to the measured geolocation is within a selected unit cell, in some cases, the grid defines a lattice of unit cells. In some instances, the coarser-geolocation-based value may be based on an identifier of the selected unit cell.

In some embodiments, the coarser-geolocation-based value may be determined by a query of a geographic information system for a place of interest including a measured geolocation. In some cases, the coarser-geolocation-based value may be based on an identifier of the place of interest. In other cases, the coarser-geolocation-based value may be determined by wirelessly receiving, with a radio of the mobile computing device 64, an identifier of a wireless transmitter in range of a measured geolocation. In some instances, the coarser-geolocation-based value may be based on an identifier of the wireless transmitter.

In some embodiments, the mobile computing device 64 may generate a limited-use authentication credential from a first cryptographic hash value based on the shared-secret value and the use-limiting value and a second cryptographic hash value based on the first cryptographic hash value and the coarser-geolocation based value.

In some embodiments, the mobile computing device 64 may determine a first value corresponding to a first coordinate of a measured geolocation and a second value corresponding to a second coordinate of the measure geolocation to generate a coarser-geolocation-based value. In some instances, the mobile computing device 64 may generate a limited-use authentication credential from a first cryptographic hash value based on the shared-secret value and the use-limiting value, a second cryptographic hash value based on the first cryptographic hash value and the first coordinate of the measured geolocation, and a third cryptographic hash based on the second cryptographic hash value and the second coordinate of the measured geolocation.

In some embodiments, the mobile computing device 64 may determine a first key based on an exclusive-or (XOR) operation of a first value and a shared-secret value. In some cases, the first value may be a system constant or other sources of entropy. In some instances, the mobile computing device may determine a second key based on an exclusive-or (XOR) operation of a second value and a shared-secret value. In some cases, the second value may be a different system constant or other source of entropy. In some cases, the second key may be different from the first key, and in some cases, the second value may be different from the first value. In response to the determination of the first key and the second key, the mobile computing device 64 may determine a first cryptographic hash value based on a coarser-geolocation-based value and the first key and a second cryptographic hash value based on the first cryptographic value and the second key. In some cases, the first cryptographic hash value may not be based on the second key. Some embodiments may determine the TLOTP with a HMAC-based One-time Password Algorithm specified by IETF RFC 4226.

In some embodiments, the mobile computing device 64 may generate a single cryptographic hash value based on a shared-secret value, a coarser-geolocation-based value, and a use-limiting value. In some instances, the mobile computing device 64 may determine an offset integer from a first subset of digits of the single cryptographic hash value and not from a second subset of digits of the single cryptographic hash value. In some cases, the mobile computing device 64 may select a third subset of digits of the single cryptographic hash value in positions corresponding to the offset integer. In some cases, the mobile computing device 64 may generate a limited-use authentication credential from the third subset of digits of the single cryptographic hash value, but not from a fourth subset of digits of the single cryptographic hash value, in some instances, the fourth subset may not overlap the third subset.

In some embodiments, upon generating a limited-use authentication credential, the user 62 may receive the credential, for example the credential may be displayed on a display screen of the mobile computing device 64, and may input the credential into a user interface to the browser 66, such as a keyboard, as indicated by communication 94. In other cases, the mobile computing device 64 may sent the limited-use authentication credential to the application server 16 for validation. In some embodiments, the application server 16 may receive the limited-use authentication credential from the browser 66, as indicated by communication 96. In some embodiments, the authorization server 70 may receive the limited-use authentication credential, as indicated by communication 98.

In some embodiments, in response to receiving the limited-use authentication credential, the authorization server 70 may generate an expected limited-use authentication credential to validate the received limited-use authentication credential. In other cases, the authorization server 70 may generate an expected limited-use authentication credential before the mobile computing device 64 generates a limited-use authentication credential to facilitate faster comparisons. In some embodiments, the authorization server 70 verifies and validates the received limited-use authentication credential generated by the mobile computing device 64, as indicated by communication 100. In some instances, the verification and validation of the received credential may be based on a valid geolocation of the user 62 associated with the shared secret value. In some embodiments, in response that the expected credential generated by the authorization server 70 corresponds to (e.g., matches) the received credential generated by the mobile computing device 64, the user may be authenticated. In some cases, the application server 68 receives the status of the verification, as indicated in communication 102, in some cases, the user is presented with the requested resources, as indicated in communication 104.

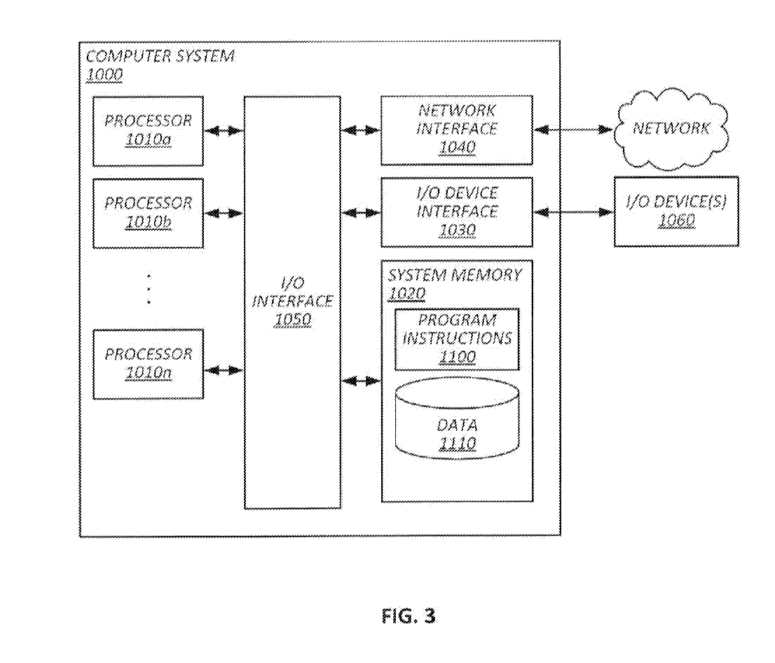

FIG. 3 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs.

The present techniques will be better understood with reference to the following enumerated embodiments:
1. A method of determining a limited-use authentication credential based on geolocation, the method comprising: receiving, with one or more processors of a credential-generating computing device, a first request to generate a limited-use authentication credential; obtaining, with one or more processors of the credential-generating computing device, a shared-secret value, wherein the shared-secret value is accessible to both of the credential-generating computing device and a remote authentication application; determining, with one or more processors of the credential-generating computing device, a measured geolocation of the credential-generating computing device; determining, with one or more processors of the credential-generating computing device, a coarser-geolocation-based value based on the measured geolocation of the credential-generating computing device, wherein the coarser-geolocation-based value is based on a coarser indication of geolocation than the measured geolocation, such that the coarser-geolocation-based value corresponds to a larger geographic area than the measured geolocation, the larger geographic area including the measured geolocation; determining, with one or more processors of the credential-generating computing device, a use-limiting value that constrains an amount of times generated credentials are valid or a duration of time over which generated credentials are valid; generating, with the credential-generating computing device, a limited-use authentication credential from one or more cryptographic hash values based on the shared-secret value, the coarser-geolocation-based value, and the use-limiting value; and outputting, with the credential-generating computing device, the limited-use authentication credential for submission to the remote authentication application, wherein the remote authentication application is configured to execute operations comprising: generating, either before or after generation of the limited-use authentication credential, an expected limited-use authentication credential based on a value indicative of a valid geolocation of a user associated with the shared secret, and determining that the expected credential corresponds to a received limited-use authentication credential output by the credential-generating computing device and, in response, causing the user to be authenticated.
2. The method of embodiment 1, wherein: the coarser-geolocation-based value is determined by operations comprising: determining an identifier of the larger-geographic area, and determining a cryptographic-hash value based on the identifier of the larger-geographic area; the coarser-geolocation-based value is based on the cryptographic-hash value based on the identifier of the larger-geographic area; and the coarser-geolocation-based value is accessible to the remote authentication application but does not reveal the larger-geographic area, or the user's measured geolocation therein, to the remote authentication application.
3. The method of any one of embodiments 1-2, wherein: the remote authentication application stores a plurality of coarser-geolocation-based values in association with the shared-secret value, the plurality of coarser-geolocation-based values corresponding to a plurality of different geolocations in which the user is permitted to be authenticated.
4. The method of any one of embodiments 1-3, comprising: receiving, with the credential-generating computing device, a second request to generate a limited-use authentication credential; determining, with the credential-generating computing device, another measured geolocation of the credential-generating computing device; accessing, with the credential-generating computing device, a set of a plurality of permitted geographic areas stored by the credential-generating computing device in which the user is permitted to be authenticated; and determining, with the credential-generating computing device, that the other measured geolocation is not in any of the permitted geographic areas and, in response, presenting an indication to the user of the determination.
5. The method of any one of embodiments 1-4, wherein determining the coarser-geolocation-based value comprises: obtaining a latitude or longitude of the credential-generating computing device; and determining the coarser-geolocation-based value based on a first subset of digits of the obtained latitude or longitude and not based on a second subset of digits of the obtained latitude or longitude, the second subset being less significant digits than the first subset.
6. The method of any one of embodiments 1-5, wherein determining the coarser-geolocation-based value comprises: selecting a unit cell of a grid in response to determining that the measured geolocation is within the selected unit cell, the grid defining a lattice of unit cells; and determining the coarser-geolocation-based value based on an identifier of the selected unit cell.
7. The method of any one of embodiments 1-6, wherein determining the coarser-geolocation-based value comprises: querying a geographic information system for a place of interest including the measured geolocation; and determining the coarser-geolocation-based value based on an identifier of the place of interest.
8. The method of any one of embodiments 1-7, wherein determining the coarser-geolocation-based value comprises: wirelessly receiving, with a radio of the credential-generating computing device, an identifier of a wireless transmitter in range of the measured geolocation; and determining the coarser-geolocation-based value based on the identifier of the wireless transmitter.
9. The method of any one of embodiments 1-8, wherein generating the limited-use authentication credential comprises: calculating a first cryptographic hash value based on the shared-secret value and the use-limiting value but not the coarser-geolocation-based value; and calculating a second cryptographic hash value based on the first cryptographic hash value and the coarser-geolocation-based value.
10. The method of any one of embodiments 1-9, wherein: the coarser-geolocation-based value comprises a first value corresponding to a first coordinate of the measured geolocation and a second value corresponding to a second coordinate of the measured geolocation; and generating the limited-use authentication credential comprises: calculating a first cryptographic hash value based on the shared-secret value and the use-limiting value; calculating a second cryptographic hash value based on the first cryptographic hash value and the first coordinate of the measured geolocation; and calculating a third cryptographic hash value based on the second cryptographic hash value and the second coordinate of the measured geolocation.
11. The method of any one of embodiments 1-10, wherein generating the limited-use authentication credential comprises: determining a first key based on an exclusive-or (XOR) operation taking a first value and the shared-secret value as inputs; determining a second key based on another XOR operation taking a second value and the shared-secret value as inputs, the second key being different from the first key, and the second value being different from the first value; calculating a first cryptographic hash value based on the coarser-geolocation-based value and the first key but not the second key; and calculating a second cryptographic hash value based on the first cryptographic value and the second key.
12. The method of any one of embodiments 1-11, wherein generating the limited-use authentication credential comprises: calculating a single cryptographic hash value based on the shared-secret value, the coarser-geolocation-based value, and the use-limiting value; determining an offset integer from a first subset of digits of the single cryptographic hash value and not from a second subset of the digits of the single cryptographic hash value; selecting a third subset of digits of the single cryptographic hash value in positions corresponding to the offset integer; and generating the limited-use authentication credential from the third subset of digits of the single cryptographic hash value but not from a fourth subset of digits of the single cryptographic hash value, the fourth subset not overlapping the third subset.
13. The method of any one of embodiments 1-14, comprising: steps for determining a coarser-geolocation-based value based on a measured geolocation; steps for generating a limited-use authentication credential; and steps for authenticating a user based on a limited-use authentication credential.
14. The method of any one of embodiments 1-15, wherein: the use-limiting value is determined by determining an amount of increments of a duration of time larger than 10-seconds that have elapsed since a predetermined time; the credential-generating computing device is a mobile computing device that generates the limited-use authentication credential with a client multi-factor authentication application installed as a native application on the credential-generating computing device; outputting the limited-use authentication credential comprises displaying the limited-use authentication credential on a display screen of the credential-generating computing device; and the limited-use authentication credential is submitted to the remote authentication application by a different computing device from the credential-generating computing device, the different computing device being a computing device upon which the user seeks to access resources for which multi-factor authentication is required.
15. The method of embodiment 14, comprising: generating, with the remote authentication application, either before or after generation of the limited-use authentication credential, an expected limited-use authentication credential based on a value indicative of a valid geolocation of a user associated with the shared secret, determining, with the remote authentication application, that the expected credential corresponds to a received limited-use authentication credential output by the credential-generating computing device and, in response, causing the user to be authenticated; and providing access to the resources upon the remote authentication application determining that the expected credential corresponds to the received limited-use authentication credential.
16. A tangible, non-transitory, machine-readable medium storing instructions that when executed by one or more processors effectuate operations comprising: obtaining, with one or more processors of an authentication application, a plurality of user authentication records, wherein: the user authentication records contain credentials by which access requests by respective users are authenticated, and respective user authentication records among the plurality of user authentication records comprise a respective shared-secret value, a respective user identifier, a respective password-based value corresponding to a respective user password, and a respective geolocation-based value; receiving, with one or more processors of the authentication application, via a network, from a remote user computing device, a request for authentication and associated values including: user identifier, password-based value, and a limited-use credential based on both a geolocation of the remote computing device or other computing device in an associated user's possession and a time determined by the remote computing device or other computing device in the associated user's possession; generating, with one or more processors of the authentication application, either before or after receiving the request, an expected limited-use authentication credential based on a value indicative of a valid geolocation of the user, a current time obtained by the authentication application, and the shared secret; determining both that the expected credential corresponds to the received limited-use authentication credential and that the received password-based value corresponds to a password-based value in an authentication record corresponding to the received user identifier; and in response to the determination, with one or more processors of the authentication application, sending an indication to another computing device that the user is authenticated.
17. The medium of embodiment 16, wherein: generating the expected limited-use authentication credential comprises: generating a first limited-use authentication credential based on a first geographic area, and generating a second limited-use authentication credential based on a second geographic area adjacent the first geographic area; and determining that the expected limited-use credential corresponds to the received limited-use credential comprises: determining that the first expected limited-use credential does not correspond to the received limited use-credential; and determining that the second expected limited-use credential corresponds to the received limited use-credential.
18. The medium of any one of embodiments 16-17, wherein: generating the expected limited-use authentication credential comprises: generating a first limited-use authentication credential based on a first geographic area and a first time, and generating a second limited-use authentication credential based on a second geographic area adjacent the first geographic area and the first time, and generating a third limited-use authentication credential based on the first geographic area and a second time that is consecutive to the first time; determining that the expected limited-use credential corresponds to the received limited-use credential comprises: determining that the first expected limited-use credential does not correspond to the received limited use-credential; determining that the second expected limited-use credential does not correspond to the received limited use-credential, and determining that the third expected limited-use credential does correspond to the received limited use-credential.
19. The medium of any one of embodiments 16-18, the operations comprising: receiving, with the remote user computing device, a request to generate a limited-use authentication credential; obtaining, with the remote user computing device, the shared-secret value corresponding to the user identifier; determining, with the remote user computing device, a measured geolocation of the remote user computing device; determining, with the remote user computing device, a coarser-geolocation-based value based on the measured geolocation of the remote user computing device, wherein the coarser-geolocation-based value is based on a coarser indication of geolocation than the measured geolocation such that the coarser-geolocation-based value corresponds to a larger geographic area than the measured geolocation, the larger geographic area including the measured geolocation; determining, with the remote user computing device, a use-limiting value that constrains a duration of time over which generated credentials are valid; and generating, with the remote user computing device, the limited-use authentication credential received by the authentication application, where the received limited-use authentication credential is generated from on one or more cryptographic hash values based on the obtained shared-secret value, the determined coarser-geolocation-based value, and the determined use-limiting value.
20. The medium of embodiment 19, wherein: the coarser-geolocation-based value is determined by operations comprising: determining an identifier of the larger-geographic area, and determining a cryptographic-hash value based on the identifier of the larger-geographic area; the coarser-geolocation-based value is based on the cryptographic-hash value based on the identifier of the larger-geographic area; and the coarser-geolocation-based value is accessible to the authentication application but does not reveal the larger-geographic area, or the user's measured geolocation therein, to the authentication application.

What is claimed is:

1. A method of determining a limited-use authentication credential based on geolocation, the method comprising:
receiving, with one or more processors of a credential-generating computing device, a first request to generate a limited-use authentication credential;
obtaining, with one or more processors of the credential-generating computing device, a shared-secret value, wherein the shared-secret value is accessible to both of the credential-generating computing device and a remote authentication application;
determining, with one or more processors of the credential-generating computing device, a measured geolocation of the credential-generating computing device;
determining, with one or more processors of the credential-generating computing device, a coarser-geolocation-based value based on the measured geolocation of the credential-generating computing device, wherein the coarser-geolocation-based value is based on a coarser indication of geolocation than the measured geolocation, such that the coarser-geolocation-based value corresponds to a larger geographic area than the measured geolocation, the larger geographic area including the measured geolocation;
determining, with one or more processors of the credential-generating computing device, a use-limiting value that constrains an amount of times generated credentials are valid or a duration of time over which generated credentials are valid;
generating, with the credential-generating computing device, a limited-use authentication credential from one or more cryptographic hash values based on the shared-secret value, the coarser-geolocation-based value, and the use-limiting value; and
outputting, with the credential-generating computing device, the limited-use authentication credential for submission to the remote authentication application,
wherein the remote authentication application is configured to execute operations comprising:
generating, either before or after generation of the limited-use authentication credential, an expected limited-use authentication credential based on a value indicative of a valid geolocation of a user associated with the shared-secret value, and
determining that the expected credential corresponds to a received limited-use authentication credential output by the credential-generating computing device and, in response, causing the user to be authenticated.

2. The method of claim 1, wherein:
the coarser-geolocation-based value is determined by operations comprising:
determining an identifier of the larger-geographic area, and
determining a cryptographic-hash value based on the identifier of the larger-geographic area;
the coarser-geolocation-based value is based on the cryptographic-hash value based on the identifier of the larger-geographic area; and
the coarser-geolocation-based value is accessible to the remote authentication application but does not reveal the larger-geographic area, or the user's measured geolocation therein, to the remote authentication application.

3. The method of claim 1, wherein:
the remote authentication application stores a plurality of coarser-geolocation-based values in association with the shared-secret value, the plurality of coarser-geolocation-based values corresponding to a plurality of different geolocations in which the user is permitted to be authenticated.

4. The method of claim 1, comprising:
receiving, with the credential-generating computing device, a second request to generate a limited-use authentication credential;
determining, with the credential-generating computing device, another measured geolocation of the credential-generating computing device;
accessing, with the credential-generating computing device, a set of a plurality of permitted geographic areas stored by the credential-generating computing device in which the user is permitted to be authenticated; and
determining, with the credential-generating computing device, that the other measured geolocation is not in any of the permitted geographic areas and, in response, presenting an indication to the user of the determination.

5. The method of claim 1, wherein determining the coarser-geolocation-based value comprises:
obtaining a latitude or longitude of the credential-generating computing device; and
determining the coarser-geolocation-based value based on a first subset of digits of the obtained latitude or longitude and not based on a second subset of digits of the obtained latitude or longitude, the second subset being less significant digits than the first subset.

6. The method of claim 1, wherein determining the coarser-geolocation-based value comprises:
selecting a unit cell of a grid in response to determining that the measured geolocation is within the selected unit cell, the grid defining a lattice of unit cells; and
determining the coarser-geolocation-based value based on an identifier of the selected unit cell.

7. The method of claim 1, wherein determining the coarser-geolocation-based value comprises:
querying a geographic information system for a place of interest including the measured geolocation; and
determining the coarser-geolocation-based value based on an identifier of the place of interest.

8. The method of claim 1, wherein determining the coarser-geolocation-based value comprises:
wirelessly receiving, with a radio of the credential-generating computing device, an identifier of a wireless transmitter in range of the measured geolocation; and
determining the coarser-geolocation-based value based on the identifier of the wireless transmitter.

9. The method of claim 1, wherein generating the limited-use authentication credential comprises:
calculating a first cryptographic hash value based on the shared-secret value and the use-limiting value but not the coarser-geolocation-based value; and
calculating a second cryptographic hash value based on the first cryptographic hash value and the coarser-geolocation-based value.

10. The method of claim 1, wherein:
the coarser-geolocation-based value comprises a first value corresponding to a first coordinate of the measured geolocation and a second value corresponding to a second coordinate of the measured geolocation; and
generating the limited-use authentication credential comprises:
calculating a first cryptographic hash value based on the shared-secret value and the use-limiting value;
calculating a second cryptographic hash value based on the first cryptographic hash value and the first coordinate of the measured geolocation; and
calculating a third cryptographic hash value based on the second cryptographic hash value and the second coordinate of the measured geolocation.

11. The method of claim 1, wherein generating the limited-use authentication credential comprises:
determining a first key based on an exclusive-or (XOR) operation taking a first value and the shared-secret value as inputs;
determining a second key based on another XOR operation taking a second value and the shared-secret value as inputs, the second key being different from the first key, and the second value being different from the first value;
calculating a first cryptographic hash value based on the coarser-geolocation-based value and the first key but not the second key; and
calculating a second cryptographic hash value based on the first cryptographic value and the second key.

12. The method of claim 1, wherein generating the limited-use authentication credential comprises:
calculating a single cryptographic hash value based on the shared-secret value, the coarser-geolocation-based value, and the use-limiting value;
determining an offset integer from a first subset of digits of the single cryptographic hash value and not from a second subset of the digits of the single cryptographic hash value;
selecting a third subset of digits of the single cryptographic hash value in positions corresponding to the offset integer; and
generating the limited-use authentication credential from the third subset of digits of the single cryptographic hash value but not from a fourth subset of digits of the single cryptographic hash value, the fourth subset not overlapping the third subset.

13. The method of claim 1, comprising:
steps for determining a coarser-geolocation-based value based on a measured geolocation;
steps for generating a limited-use authentication credential; and
steps for authenticating a user based on a limited-use authentication credential.

14. The method of claim 1, wherein:
the use-limiting value is determined by determining an amount of increments of a duration of time larger than 10-seconds that have elapsed since a predetermined time;
the credential-generating computing device is a mobile computing device that generates the limited-use authentication credential with a client multi-factor authentication application installed as a native application on the credential-generating computing device;
outputting the limited-use authentication credential comprises displaying the limited-use authentication credential on a display screen of the credential-generating computing device; and
the limited-use authentication credential is submitted to the remote authentication application by a different computing device from the credential-generating computing device, the different computing device being a computing device upon which the user seeks to access resources for which multi-factor authentication is required.

15. The method of claim 14, comprising:
generating, with the remote authentication application, either before or after generation of the limited-use authentication credential, an expected limited-use authentication credential based on a value indicative of a valid geolocation of a user associated with the shared secret,
determining, with the remote authentication application, that the expected credential corresponds to a received limited-use authentication credential output by the credential-generating computing device and, in response, causing the user to be authenticated; and
providing access to the resources upon the remote authentication application determining that the expected credential corresponds to the received limited-use authentication credential.

16. A tangible, non-transitory, machine-readable medium storing instructions that when executed by one or more processors effectuate operations comprising:
obtaining, with one or more processors of an authentication application, a plurality of user authentication records, wherein:
the user authentication records contain credentials by which access requests by respective users are authenticated, and
respective user authentication records among the plurality of user authentication records comprise a respective shared-secret value, a respective user identifier, a respective password-based value corresponding to a respective user password, and a respective geolocation-based value;
receiving, with one or more processors of the authentication application, via a network, from a remote user computing device, a request for authentication and associated values including:
user identifier,
password-based value, and
a limited-use credential based on both a geolocation of the remote computing device or other computing device in an associated user's possession and a time determined by the remote computing device or other computing device in the associated user's possession;
generating, with one or more processors of the authentication application, either before or after receiving the request, an expected limited-use authentication credential based on a value indicative of a valid geolocation of the user, a current time obtained by the authentication application, and the shared secret;
determining both that the expected credential corresponds to the received limited-use authentication credential and that the received password-based value corresponds to a password-based value in an authentication record corresponding to the received user identifier; and
in response to the determination, with one or more processors of the authentication application, sending an indication to another computing device that the user is authenticated.

17. The medium of claim 16, wherein:
generating the expected limited-use authentication credential comprises:
generating a first limited-use authentication credential based on a first geographic area, and
generating a second limited-use authentication credential based on a second geographic area adjacent the first geographic area; and
determining that the expected limited-use credential corresponds to the received limited-use credential comprises:
determining that the first expected limited-use credential does not correspond to the received limited use-credential; and
determining that the second expected limited-use credential corresponds to the received limited use-credential.

18. The medium of claim 16, wherein:
generating the expected limited-use authentication credential comprises:
generating a first limited-use authentication credential based on a first geographic area and a first time, and
generating a second limited-use authentication credential based on a second geographic area adjacent the first geographic area and the first time, and
generating a third limited-use authentication credential based on the first geographic area and a second time that is consecutive to the first time;
determining that the expected limited-use credential corresponds to the received limited-use credential comprises:
determining that the first expected limited-use credential does not correspond to the received limited use-credential;
determining that the second expected limited-use credential does not correspond to the received limited use-credential, and
determining that the third expected limited-use credential does correspond to the received limited use-credential.

19. The medium of claim 16, the operations comprising:
receiving, with the remote user computing device, a request to generate a limited-use authentication credential;
obtaining, with the remote user computing device, the shared-secret value corresponding to the user identifier;
determining, with the remote user computing device, a measured geolocation of the remote user computing device;
determining, with the remote user computing device, a coarser-geolocation-based value based on the measured geolocation of the remote user computing device, wherein the coarser-geolocation-based value is based on a coarser indication of geolocation than the measured geolocation such that the coarser-geolocation-based value corresponds to a larger geographic area than the measured geolocation, the larger geographic area including the measured geolocation;
determining, with the remote user computing device, a use-limiting value that constrains a duration of time over which generated credentials are valid; and
generating, with the remote user computing device, the limited-use authentication credential received by the authentication application, where the received limited-use authentication credential is generated from on one or more cryptographic hash values based on the obtained shared-secret value, the determined coarser-geolocation-based value, and the determined use-limiting value.

20. The medium of claim 19, wherein:
the coarser-geolocation-based value is determined by operations comprising:
determining an identifier of the larger-geographic area, and
determining a cryptographic-hash value based on the identifier of the larger-geographic area;
the coarser-geolocation-based value is based on the cryptographic-hash value based on the identifier of the larger-geographic area; and
the coarser-geolocation-based value is accessible to the authentication application but does not reveal the larger-geographic area, or the user's measured geolocation therein, to the authentication application.
